(19) United States
(12) Patent Application Publication
(10) Pub. No.: US 2026/0102728 A1
(43) Pub. Date: Apr. 16, 2026

(54) WET SCRUBBER FOR CAPTURING DUST FROM A BULK POWDER

(71) Applicant: Halliburton Energy Services, Inc., Houston, TX (US)

(72) Inventors: Craig Allen SNEED, Duncan, OK (US); Bryan Clint WALKER, Duncan, OK (US)

(73) Assignee: Halliburton Energy Services, Inc., Houston, TX (US)

(21) Appl. No.: 18/915,717

(22) Filed: Oct. 15, 2024

(51) Int. Cl. B01D 47/02; E21B 33/13; E21B 43/26; E21B 43/267

(52) U.S. Cl. CPC B01D 47/025; B01D 2247/106; B01D 2247/12

(57) ABSTRACT

A wet scrubber can be used to capture dust particulates from a bulk powder conveyed into a mixing system. The mixing system can be used to form a treatment fluid for use in an oil and gas operation, such as a cement slurry. The wet scrubber includes a first section having two sets of baffles that create a first and second stage. Air and the dust particulates flow into and through the baffles of the first stage and turbulently mixed with water in the wet scrubber to capture the dust particulates. The air and any remaining dust particulates then flow into and through the baffles of the second stage and turbulently mixed with the water. One or two additional sections, each having baffles, can be included to accommodate varying air flows into the scrubber. The baffles in the various sections can be lower in the water than other sections.

### TECHNICAL FIELD

Bulk powders can be mixed with water to form treatment fluids used in oil and gas operations. Bulk powders include cement and other additives. When the bulk powder is conveyed into a mixer head, dust particulates can be created. A wet scrubber can be used to capture the dust particulates from the mixer head.

### BRIEF DESCRIPTION OF THE FIGURES

The features and advantages of certain embodiments will be more readily appreciated when considered in conjunction with the accompanying figures. The figures are not to be construed as limiting any of the embodiments.

FIG. 1 is a schematic illustrating a system for transferring a dry bulk powder from a storage container to a mixer head and a wet scrubber for capturing dust from the mixer head.

FIG. 2 is a front cross-sectional view of the wet scrubber connected to a water tank according to certain embodiments.

FIG. 3 is a front cross-sectional view of the wet scrubber being attached to an inside of a water tank according to certain other embodiments.

FIG. 4 is a front cross-sectional view of the wet scrubber showing the water level changing within different stages and turbulent flow occurring as air and dust enter the wet scrubber according to certain embodiments.

FIG. 5 is a front cross-sectional view of the wet scrubber showing baffles in a first section and a second section.

FIG. 6A is a back cross-sectional view of the wet scrubber showing the second section according to certain embodiments.

FIG. 6B is a side view of the wet scrubber showing the first and second sections taken along lines 6B of FIG. 6A.

FIG. 7A is a back cross-sectional view of the wet scrubber showing a third section according to certain other embodiments.

FIG. 7B is a side view of the wet scrubber showing the first, second, and third sections taken along lines 7B of FIG. 7A.

FIG. 8 is a top view of the wet scrubber showing the first, second, and third sections of FIG. 7A.

### DETAILED DESCRIPTION

Oil and gas hydrocarbons are naturally occurring in some subterranean formations. In the oil and gas industry, a subterranean formation containing oil and/or gas is referred to as a reservoir. A reservoir can be located under land or offshore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from a reservoir is called a reservoir fluid.

As used herein, a “fluid” is a substance having a continuous phase that can flow and conform to the outline of its container when the substance is tested at a temperature of 71 °F (22 °C) and a pressure of one atmosphere "atm" (0.1 megapascals "MPa"). A fluid can be a liquid, gas, or a supercritical fluid. A homogenous fluid has only one phase; whereas a heterogeneous fluid has more than one distinct phase. A colloid is an example of a heterogeneous fluid. A heterogeneous fluid can be a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase. As used herein, the term "base fluid" means the solvent of a solution or the continuous phase of a heterogeneous fluid and is the liquid that is in the greatest percentage by volume of a treatment fluid.

A well can include, without limitation, an oil, gas, or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet radially of the wellbore. As used herein, “into a subterranean formation” means and includes into any portion of the well, including into the wellbore, into the near-wellbore region via the wellbore, or into the subterranean formation via the wellbore.

During wellbore operations, it is common to introduce a treatment fluid into the well. Examples of common treatment fluids include, but are not limited to, drilling fluids, cement slurries, completion fluids, and stimulation fluids. As used herein, a treatment fluid is a fluid designed and prepared to resolve a specific condition of a well or subterranean formation, such as for cementing, stimulation, isolation, enhanced oil recovery, chemical squeezes, pressure support floods, gravel packing, or control of gas or water coning. The term “treatment fluid” refers to the specific composition of the fluid as it is being introduced into a well. The word “treatment” in the term “treatment fluid” does not necessarily imply any particular action by the fluid.

A portion of a wellbore can be an open hole or cased hole. In an open-hole wellbore portion, a tubing string can be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include but are not limited to the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

A wellbore is formed using a drill bit. A drill string can be used to aid the drill bit in drilling through the subterranean formation to form the wellbore. The drill string can include a drilling pipe. During drilling operations, a drilling fluid, sometimes referred to as a drilling mud, may be circulated downwardly through the drilling pipe, and back up the annulus between the wellbore and the outside of the drilling pipe. The drilling fluid performs various functions, such as cooling the drill bit, maintaining the desired pressure in the well, and carrying drill cuttings upwardly through the annulus between the wellbore and the drilling pipe.

During well completion, it is common to introduce a cement composition into an annulus in a wellbore. For example, in a cased-hole wellbore, a cement composition can be placed into and allowed to set in the annulus between the wellbore and the casing in order to stabilize and secure the casing in the wellbore. By cementing the casing in the wellbore, fluids are prevented from flowing into the annulus. Consequently, oil or gas can be produced in a controlled manner by directing the flow of oil or gas through the casing and into the wellhead. Cement compositions can also be used in primary or secondary cementing operations, well-plugging, or squeeze cementing. In cementing operations, a cement composition is circulated down through a casing string or drill string, through float equipment, and up into the annulus of the wellbore. In reverse cementing operations, a cement composition is circulated down through the annulus and up through float equipment.

Stimulation treatment fluids can include fracturing fluids and acidizing fluids. Stimulation techniques can be used to help increase or restore oil, gas, or water production. One example of a stimulation technique is hydraulic fracturing. In hydraulic fracturing, a fracturing fluid, which can also be an acidizing fluid, is pumped at a sufficiently high flow rate and high pressure through the wellbore and into the near wellbore region to create or enhance a fracture in the subterranean formation. A frac pump is used to pump the fracturing fluid into the wellbore and formation at high rates and pressures, for example, at a flow rate in excess of the fracture gradient of the subterranean formation. The fracturing fluid can include proppant that is used to prop the fractures open to allow the flow of reservoir fluids through the fracture.

In the field, treatment fluids are mixed at the wellsite and then introduced into the subterranean formation. The treatment fluid can include a bulk powder as one of its ingredients along with water, oil, a gas, and optionally other additives. As used herein, the term “bulk powder” means an initially dry substance containing discrete particles with varying particle sizes. By way of example, the bulk powder can include bulk particles, mesoscopic particles, nanoparticles, or combinations thereof. As used herein, a "bulk particle" is a particle having a particle size greater than 1 micron. As used herein, a "mesoscopic particle" is a particle having a particle size in the range of 1 micron to 0.1 micron. As used herein, a "nanoparticle" is a particle having a particle size of less than 0.1 micron. As used herein, the term "particle size" refers to the volume surface mean diameter ("Ds"), which is related to the specific surface area of the particle. The volume surface mean diameter may be defined by the following equation: Ds = 6/(ΦsAwρₚ), where Φs = sphericity; Aw = specific surface area; and ρₚ = particle density. The bulk powder can also include dust particulates. As used herein, “dust particulates” means particulates having a particle size less than or equal to a size wherein the particulates remain in the air instead of settling into a container, such as a mixer head.

The bulk powder can be any type of dry substance that contains dust particulates and can include without limitation cement, proppant, sand, or other additives used to form the treatment fluid. By way of example, a cement slurry is mixed at the wellsite and then introduced into the wellbore. As used herein, a "cement slurry" is a mixture of at least cement and water. A cement slurry can include additives, such as set retarders, set accelerators, and weighting agents. As used herein, the term "cement" means an initially dry substance that develops compressive strength or sets in the presence of water. Some examples of cement include, but are not limited to, Portland cements, gypsum cements, high alumina content cements, slag cements, high magnesia content cements, sorel cements, and combinations thereof. A cement slurry is a heterogeneous fluid including water as the base fluid and continuous phase of the slurry and the cement (and any other insoluble particles) as the dispersed phase. The continuous phase of a cement slurry can include dissolved substances.

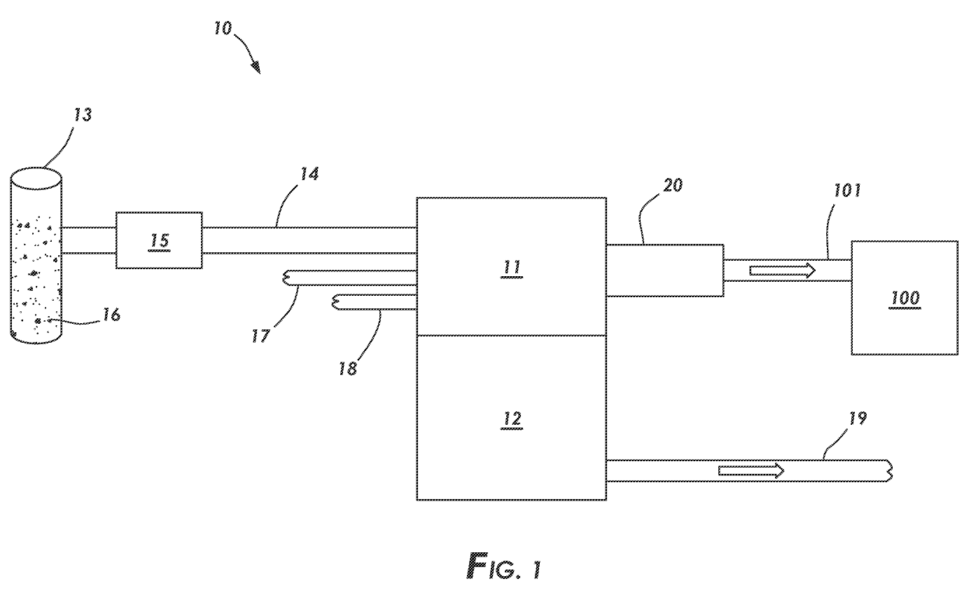

With reference to FIG. 1, a treatment fluid is prepared by a mixing system 10. A bulk powder 16 can be pneumatically conveyed from a storage container 13, (e.g., a silo or similar container that is capable of storing a large amount of the bulk powder) into a mixer head 11. A blower 15 can be used to convey the bulk powder 16 from the storage container 13 into the mixer head 11 via a feed tube 14. Water or another liquid that is required to be mixed with the bulk powder 16 to form the treatment fluid can be conveyed into the mixer head 11 via a water feed tube 17, and any additives that may be included can be conveyed into the mixer head 11 via an additive feed tube 18. The ingredients can then be mixed together via a mixer 12. The treatment fluid can then exit the mixer 12 via a treatment fluid outlet 19 and sent to pumping equipment at the wellhead for introduction into the subterranean formation.

The pneumatic conveyance of the bulk powder 16 into the mixer head 11 can cause dust particulates to remain suspended in the air. By way of example, dust particulates can generally include particulates with a particle size less than 400 micrometers. Thus, the air from the pneumatic conveyance and dust particulates are generally removed from the system. The air and dust particulates can be removed from the mixer head 11, for example, via a blower or fan 20. Current technologies utilize dry air filters adjacent to the fan 20 to capture the dust particulates while allowing the air to be removed from the mixer head 11. However, there are several problems with using dry air filters. One problem is the air filters can become clogged quickly – especially in situations in which there is a large concentration of dust particulates in the air stream. In this situation, the air filters must be removed, the filters cleaned by shaking off or otherwise removing the dust particulates from the air filters, and the air filters reinserted into the fan area. Another even more significant problem with using dry air filters is that any humidity at the location of the mixing system 10 can cause the dry dust particulates that are captured by the filters to become embedded within the air filters. In this situation, the dry air filters are not capable of being cleaned and re-used; and thus, must be discarded and new air filters must be used. When the bulk powder is cement, the humidity can cause the cement dust particulates to set onto surfaces of the dry air filters. Setting occurs when the cement dust particulates combine with water vapor in the atmosphere and become hard or solid. With high relative humidity, for example greater than 40%, more of the cement dust particulates can coat the filters and set faster on the filters compared to lower relative humidities.

Other technologies that try to overcome the problems associated with the use of dry air filters include a wet scrubber. However, there are several problems associated with current wet scrubbers used in the oil and gas industry. One such problem is that wet scrubbers may only operate when there is a constant air pressure/flow into the wet scrubber. Another significant problem is that wet scrubbers may only be capable of filtering out dust particulates that are greater than 2 to 3 micrometers. This can result in dust particulates in the nanometer range not being filtered out.

Therefore, there is a need and an ongoing industry-wide concern for being able to combat the problems associated with using dry air filters or current wet scrubber designs for removing dust particulates from a treatment fluid mixing system. It has been discovered that a wet scrubber can be used instead of dry air filters to capture dust particulates and can operate at varying air pressures/flows.

It is to be understood that the discussion of the various embodiments regarding the dust particulates, mixer, and wet scrubber are intended to apply to the system and method embodiments without the need to repeat the embodiments for both the systems and methods throughout. Any reference to the units “gallons” means US gallons.

Referring back to FIG. 1, the mixing system 10 can include numerous additional components from the components shown. The mixing system 10 can further include a transport trailer. The transport trailer can transport the bulk powder 16 to the storage container 13, for example, from a warehouse or manufacturing plant. The bulk powder 16 can be transferred from the transport trailer into the storage container 13 via a transfer device, such as a transfer tube, an open conveyor, or a closed conveyor. Flow meter devices, electrical components such as a power source and power supply cords, pumps, and storage containers for the water and other additives, for example, can also be part of the mixing system 10.

The bulk powder 16 can be pneumatically conveyed indirectly into the mixer 12, also known as a mixing tub, from a mixer head 11. The bulk powder 16 and other dry ingredients, such as additives, can be added to the mixer head 11 and mixed together. The methods include conveying water into the mixer head 11. Although shown with the water feed tube 17 feeding into the mixer head 11, it is to be understood that the water feed tube 17 can feed directly into the mixer 12. The bulk powder and other dry ingredients can be fed from the mixer head 11 and into the mixer 12 to be mixed with water from the water feed tube 17 to form a treatment fluid. It is to be understood that the water with reference to the mixing system 10 can include dissolved substances such as water-soluble salts. Oil can also be included in the water or fed into the mixer head via a separate feed tube (not shown). Accordingly, the treatment fluid can be a slurry, an emulsion, or an invert emulsion. As can be seen, the treatment fluid that is formed within the mixer 12 is removed from the mixer 12, for example via a pump, through a treatment fluid outlet 19 where it is then introduced into a subterranean formation. The treatment fluid can be introduced close to the time the treatment fluid was formed in the mixer or it can be held in a holding device until ready for introduction into the subterranean formation.

According to any of the embodiments, the treatment fluid is a cement slurry and the bulk powder is cement. According to any of the other embodiments, the treatment fluid is a fracturing fluid, and the bulk powder is proppant, or a spacer fluid and the bulk powder is an additive.

Dust particulates are created during the pneumatic conveyance of the bulk powder 16 into the mixer head 11. Optional additives that are in dry form can also be part of the dust particulates. The amount of dust particulates that is created can vary. The dust particulates can include sub-micron-sized particulates, for example bulk cement having a particle size less than 10 nanometers. A fan 20 located at a top of the mixer head 11 can suck the dust particulates and air from the mixer head 11 to remove the dust particulates/air and convey it into the wet scrubber 100.

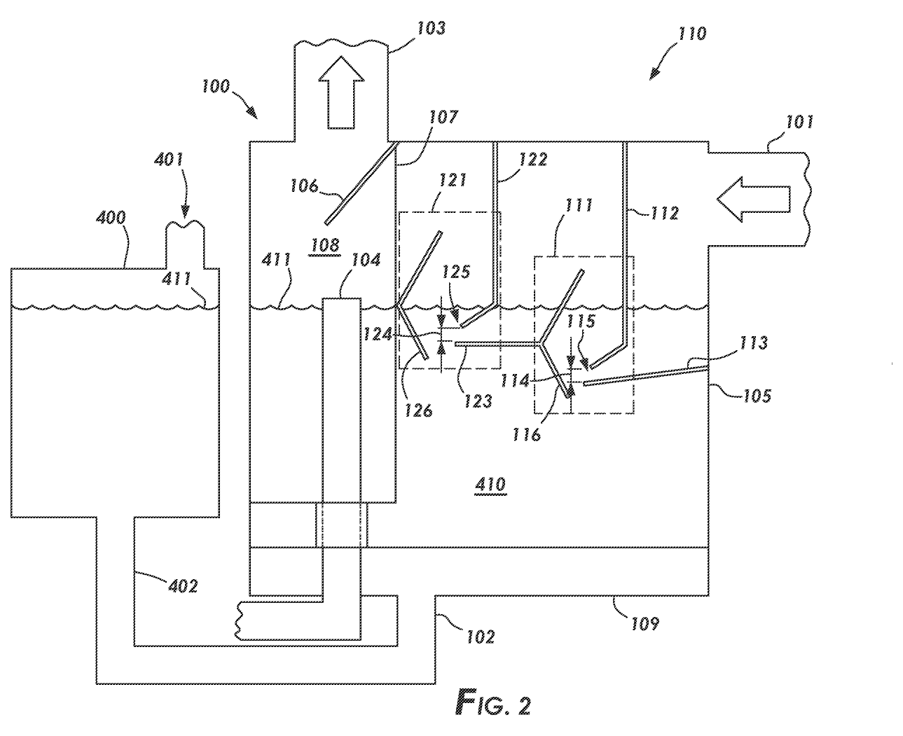

Turning to FIG. 2, the wet scrubber 100 includes a housing 105. The housing 105 can include a top, 2 sides, and a bottom 109. The housing 105 can have dimensions with a height along the 2 sides ranging from 1 to 5 feet (0.3 to 1.5 meters), a length spanning across the top and bottom ranging from 1 to 5 feet (0.3 to 1.5 meters), and a depth spanning from a front of the housing to the back of the housing ranging from 1 to 5 feet (0.3 to 1.5 meters). The components of the housing 105 can be made from the same materials or different materials. The materials for the housing 105 can be opaque or transparent. The materials for the housing 105 can be selected from the group consisting of pure metals or metal alloys such as aluminum, carbon steel, or stainless steel; or hard plastics such as polyvinyl chloride (PVC), acrylics, or high-density polyethylene (HDPE); and combinations thereof. Preferably, the material(s) for the housing 105 are selected from non-corrodible materials. Alternatively, the inside of the housing 105 that will be in contact with the water can be coated with a material that reduces or prevents corrosion to the housing. In this manner, water contained within the housing is less likely to corrode the housing. A transparent material that forms the front and back of the housing 105 may be useful so a person can visually ensure the proper functioning of the wet scrubber 100.

The wet scrubber 100 includes an air inlet 101 in which the dust particulates and the air enter the wet scrubber 100 from the mixer head 11. The air inlet 101 includes an opening into the wet scrubber 100 and a rigid or flexible tube or hose that connects to the mixer head 11 and/or fan 20. The air inlet 101 can be located at a top of one of the 2 sides of the housing 105. The air inlet 101 can have a circular cross section or other geometric cross sections. The air inlet 101 opening into the wet scrubber can have dimensions ranging from a diameter or a longest side of a perimeter of 4 to 16 inches (10.2 to 40.6 centimeters). The dimensions of the air inlet opening can be selected such that the dust particulates and the air from the mixer head 11 can enter into all of the sections of the wet scrubber 100 (e.g., a first section, second section, and third section). The air flow at which the dust particulates and air enter the wet scrubber 100 via the air inlet 101 is variable and dependent on the fan speed of the fan 20 as well as the pressure during the pneumatic conveyance of the bulk powder 16 into the mixer head 11. By way of example, the air flow in the air inlet 101 can range from 0.25 to 1,000 or greater cubic feet per minute (ft³/min. or cfm) (0.006 to 28.32 cubic meters per minute “m³/min.”).

Still with reference to FIG. 2, the wet scrubber 100 can include a water inlet 102 that can be located at the bottom 109 of the housing 105. According to this embodiment, the bottom 109 of the housing 105 is closed. The water inlet 102 can also be located at any point along a side of the housing 105, for example, the side that is opposite from the air inlet 101. A pump can be used to pump water from the water tank until the desired volume of water in the housing is achieved. The water inlet 102 can receive water 410 from a water tank 400. The water 410 can be freshwater, brackish water, brine, or seawater. The water 410 can be added to the water tank 400 via an inlet 401. The water 410 contained within the water tank 400 can fill the housing 105 with a volume of water 410 via an outlet 402 and the water inlet 102. The volume of water 410 contained within the housing 105 can vary, for example depending on the dimensions of the housing and the desired water level. The volume of water 410 contained within the housing 105 can be in a range, for example, 20 to 200 gallons (75.7 to 757.1 liters). The water 410 in the water tank 400 and the housing 105 will have a water level 411. As can be seen, the water level 411 in the water tank 400 and the water level 411 contained within the housing 105 is the same when using the water outlet 402 and the water inlet 102. A water outlet 104 can also be included within the housing 105. The water outlet 104 can have an open top and extend through the bottom 109 of the housing 105 whereby if the water level 411 within the housing 105 becomes too high, then the water will flow into the open top of the water outlet 104 and out of the housing 105 to lower the water level 411 to a desired level. According to any of the embodiments, the desired water level 411 is below the entirety of the air inlet 101.

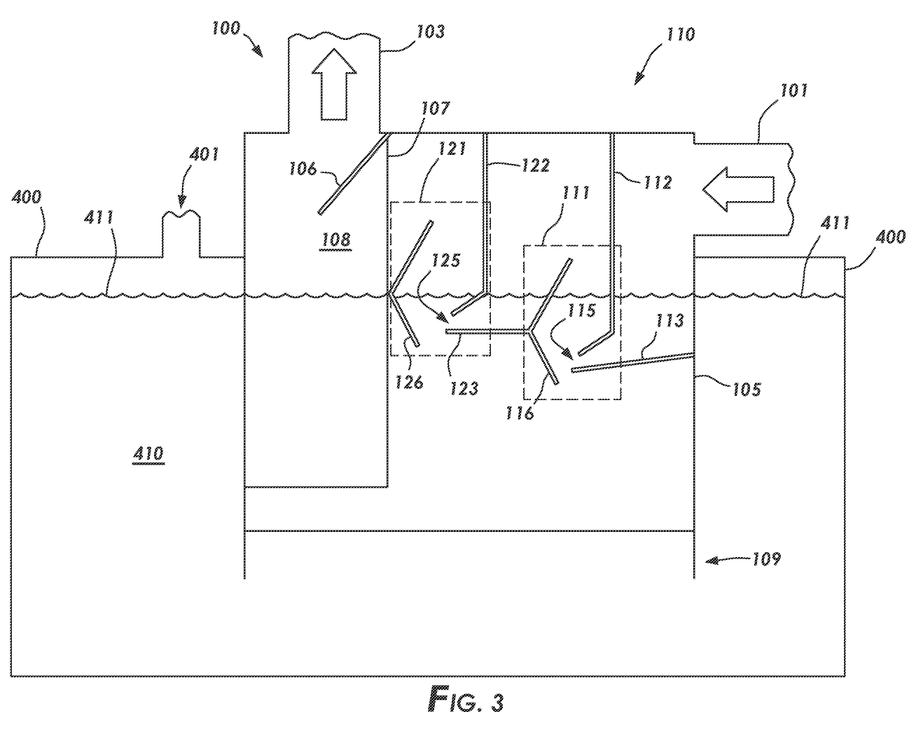

According to other embodiments and as shown in FIG. 3, the bottom 109 of the housing 105 can be open, and the wet scrubber 100 can be removably or permanently attached to an inside of the water tank 400. The water level 411 in the housing 105 will be the same as the water level 411 in the water tank 400. The wet scrubber 100 can be attached to a desired location in relation to the top of the water tank 400 such that a desired water level 411 in the housing 105 is present. That is, if the water level 411 in the housing 105 is too high, then the wet scrubber 100 can be raised higher in relation to the top of the water tank 400, which will lower the water level in the housing or vice versa. Alternatively, the amount of water in the water tank 400 can be increased or decreased until the desired water level 411 is achieved.

The wet scrubber 100 includes a first section 110. The first section 110 includes a first set of baffles creating a first stage 111 and a second set of baffles creating a second stage 121. The first set of baffles can include an enter baffle 112, a bottom baffle 113, and a turning baffle 116. The second set of baffles can include an enter baffle 122, a bottom baffle 123, and a turning baffle 126. It is to be understood that the discussion regarding any of the baffles, except where specifically noted with differences, applies equally to the particular baffle regardless of which section or stage the baffle is located within. By way of example, any discussion related to the geometry and/or location of an “entry baffle” applies to all of the entry baffles located in the wet scrubber. All of the baffles can be made of a rigid material, such as pure metals or metal alloys such as aluminum, carbon steel, or stainless steel; or hard plastics such as polyvinyl chloride (PVC), acrylics, or high-density polyethylene (HDPE); and combinations thereof. Preferably, the material(s) for the baffles are selected from non-corrodible materials. Alternatively, the baffles can be coated with a material that reduces or prevents corrosion to the baffles. All of the baffles can be secured within the housing 105 for example via welding, spot welding, or an adhesive.

The enter baffle 112 of the first stage 111 can include a vertical portion that is located a distance from the side of the housing 105 where the air inlet 101 is located; and can include an angled portion that angles away from vertical portion and the side of the housing where the air inlet 101 is located. The angle can be, for example, in a range of 95° to 125°. The bottom baffle 113 can be located perpendicular to or mostly perpendicular to the vertical portion of the enter baffle 112 and can span from the side of the housing 105 where the air inlet 101 is located to an area adjacent to an end of the angled portion of the enter baffle 112. In this manner, the ends of the enter baffle 112 and the bottom baffle 113 are located next to each other. A space between these ends of the enter baffle 112 and the bottom baffle 113 can form an orifice 115. The orifice 115 can have a height 114. The turning baffle 116 can be located a distance from the orifice 115 and have 2 segments that form an angle. The angle of the 2 segments of the turning baffle 116 can be in a range of 145° to 180°. An end of the lower of the 2 segments can be located below the end of the bottom baffle 113 and thus, below the orifice 115. The length of the upper segment can be selected such that a space exists between the top of the housing 105 and the end of the upper segment to allow the dust particulates and air to flow over the top of the turning baffle 116 and into the second stage 121.

One end of the bottom baffle 123 can be connected to the common point of the 2 segments of the turning baffle 116, while the other end of the bottom baffle 123 forms an orifice 125 with the end of the angled portion of the enter baffle 122. The bottom baffle 123 can be perpendicular to the vertical portion of the enter baffle 122 as shown, or it can be angled as is shown with enter baffle 112. The set of baffles of the second stage 121 can have the same geometries as those of the set of baffles of the first stage 111. By way of example, the angle of the enter baffle 122 and the turning baffle 126 can be the same as the angle of the enter baffle 112 and the turning baffle 116. The heights 114/214 of the orifices 115/125 can range from 0.25 to 2 inches (6.35 to 50.8 millimeters). The height 124 of the orifice 125 in the second stage 121 can be the same or different than the height 114 of the orifice 115 in the first stage 111. By way of example and as shown, the height 124 of the orifice 125 in the second stage 121 can be greater than the height 114 of the orifice 115 in the first stage 111, for example in a range of 5% to 20% greater. The first stage orifice height can be selected to limit the flow through the first stage, whereas the second stage orifice may not need to limit flow and can be larger to decrease the overall back pressure in the second stage. According to any of the embodiments, each of the second set of baffles in the second stage 121 (i.e., the enter baffle 122, bottom baffle 123, and turning baffle 126) are located closer to the top of the housing 105 and higher in relation to the water level 411 than the first set of baffles in the first stage 111. By way of example, the length of the vertical portion of enter baffle 122 can be less than the length of the vertical portion of enter baffle 112.

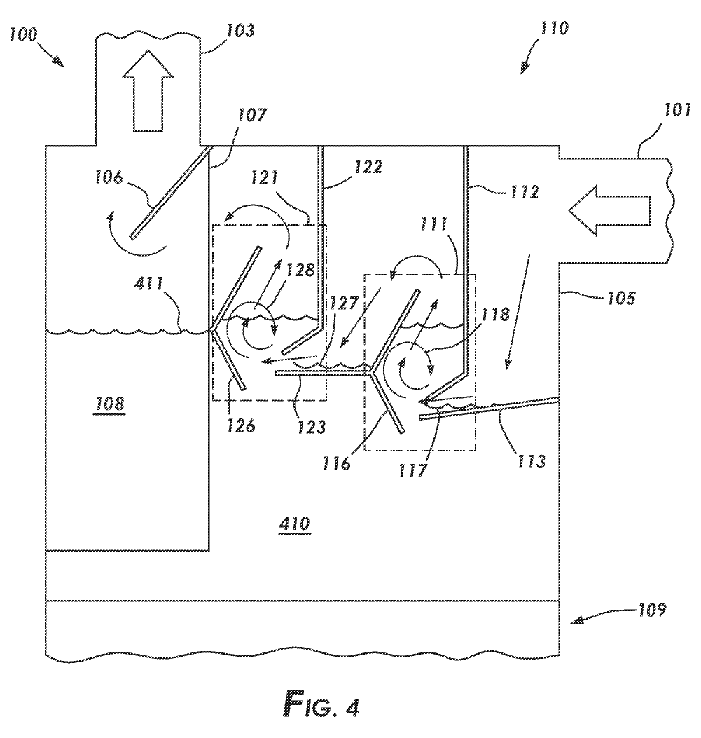

Turning now to FIG. 4, the following discussion relates to how the dust particulates and air flow through the wet scrubber 100. The air and the dust particulates enter the housing 105 via the air inlet 101 at a specific yet variable air pressure. The air and the dust particulates flow down towards the bottom baffle 113 due to the vertical portion of the enter baffle 112 forcing the air and the dust particulates down. As can be seen, the water level 117 in the area defined by the enter baffle 112 and bottom baffle 113 can be forced down compared to the water level 411 in the rest of the housing 105. The air and the dust particulates then jet out through the orifice 115 and hit the lower segment of the turning baffle 116, which causes a turbulent swirling or circular flow 118 in the area defined between the enter baffle 122 and the turning baffle 126. As used herein, the term “turbulent” and all grammatical variations thereof in the context of fluid dynamics means fluid motion characterized by chaotic changes in pressure and flow velocity, and is in contrast to laminar flow, which occurs when a fluid flows in parallel layers with no disruption between those layers. Accordingly, the turbulent flow does not have to be completely circular but can swirl and move in other directions as well. The turbulent flow creates air/water droplets allowing the air and the dust particulates to interact with and mix with the water 410 and then flows up and over the turning baffle 116 to enter the second stage 121. Some or all of the dust particulates can be captured by the air/water 410 droplets created by the turbulent swirling flow 118 in the first stage 111. The process is repeated in the second set of baffles, whereby the air and any remaining dust particulates flow down towards the bottom baffle 123 due to the vertical portion of the enter baffle 122 and out through the orifice 125. The water level 127 at the bottom baffle 123 can be higher than the water level 411 in the rest of the housing 105. The air and any remaining dust particulates then hit the lower segment of the turning baffle 126, which causes a swirling flow 128 in the area defined between the enter baffle 122 and the turning baffle 126. Any remaining dust particulates from the first stage 111 can be captured by the water 410 in the second stage 121. The air, now preferably without any of the dust particulates, then flows over the upper segment of the turning baffle 126 and can contact a drying baffle 106 before exiting the wet scrubber 100 via an air outlet 103. Any water vapor can collect on the drying baffle 106 and fall back into the water 410 in the housing 105.

If the air pressure entering from the air inlet 101 is too great, then the water level 117 in the first stage 111 can be pushed completely below the bottom baffle 113 and the lower segment of the turning baffle 116 wherein little to no swirling flow 118 can occur. This also reduces the air flow going into the second stage 121 such that the air and dust particulates flowing through the orifice 125 may not be sufficient to cause the turbulent swirling flow 128 necessary to create air/water droplets that capture the dust particulates. Accordingly, the first and second set of baffles in the first stage 111 and second stage 121 can be raised or lowered or the water level 411 in the housing can be raised or lowered (in relation to the top of the housing) such that turbulent swirling flow 118/128 is achieved in at least the first stage 111 and preferably also in the second stage 121.

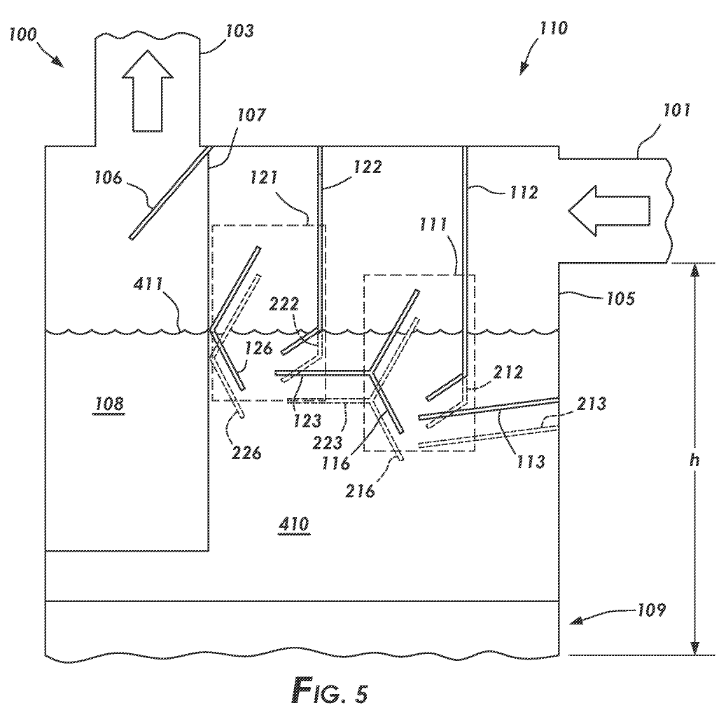

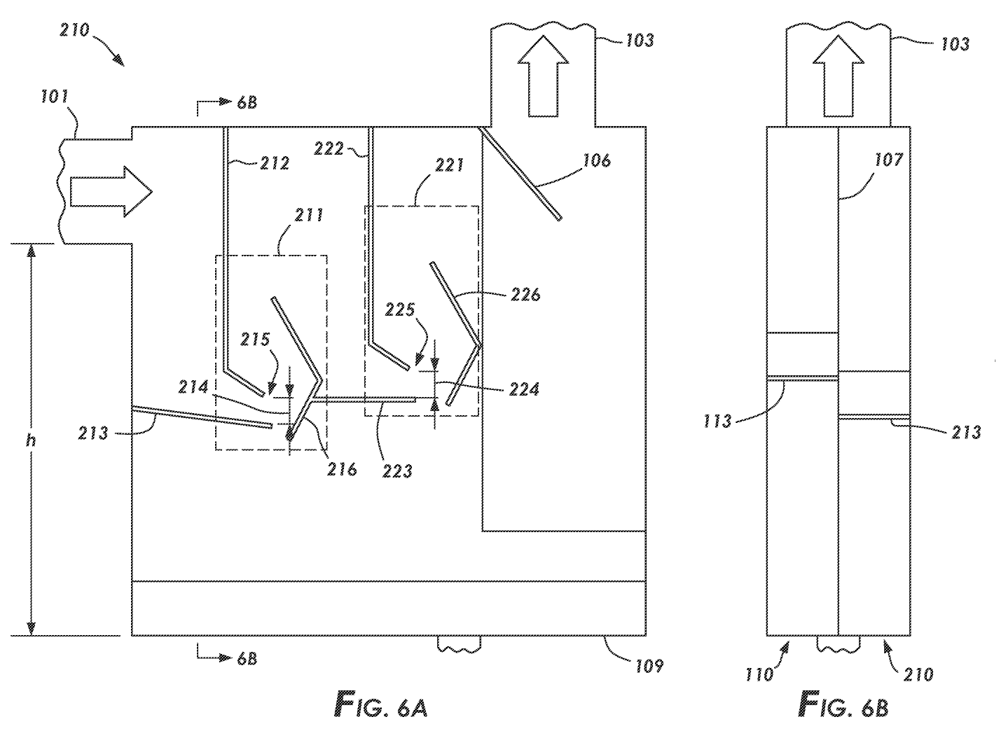

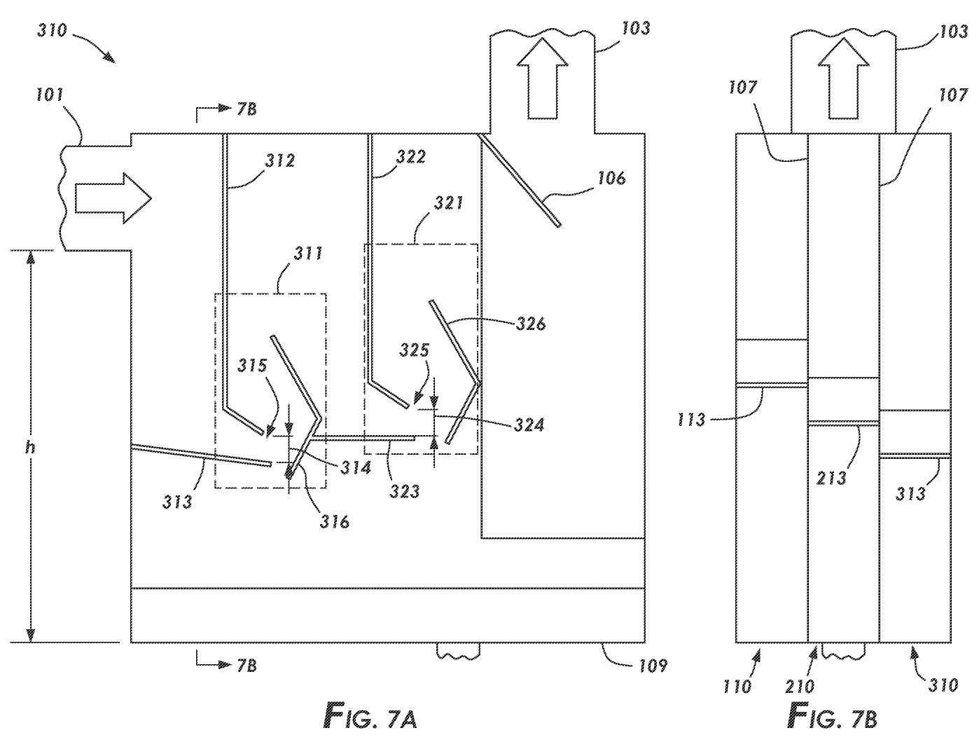

A significant disadvantage to current wet scrubbers is they are incapable of accommodating air pressure/flow that is greater than a pre-determined level to adequately scrub or capture dust particulates. According to any of the embodiments, the wet scrubber 100 further includes a second section 210, or a second section 210 and a third section 310, as shown in FIGS. 5-7B. There can also be more than 3 sections (not shown), for example a fourth section, fifth section, etc. Every section can include at least 2 stages, although each section can include additional stages, such as a third stage, fourth stage, etc. As can be seen, for example in FIG. 5, the wet scrubber 100 can further include a solid section partition 107 that partially spans from the side of the housing 105 where the air inlet 101 is located towards the opposite side of the housing, and partially from the top of the housing towards the bottom of the housing. When there are 2 sections, for example the first section 110 and a second section 210, the section partition 107 can be centrally located between the front of the housing to the back of the housing, for example as shown in FIG. 6B to separate the first and second sections from each other. In this manner, the first section 110 will be located at the front of the housing 105 on one side of the section partition 107 and the second section 210 will be located at the back of the housing 105 on the other side of the section partition 107. In the embodiments where there are 3 total sections, there will be 2 total section partitions 107 – one that separates the first section 110 from the second section 210 and the other one that separates the second section 210 from the third section 310, for example as shown in FIG. 7B.

An opening 108 can be located adjacent to an edge of the section partition(s) 107 such that water 410 can flow between the sections. The drying baffle 106 and the air outlet 103 can be located in this opening 108 at the top of the housing 105 such that air flow and water vapor from all the sections can come in contact with the drying baffle 106 and flow out the air outlet 103. An opening can also be located at or near the bottom of the housing 105 to allow water to flow between the sections.

FIG. 6A shows the second section 210 located at a back side of the housing 105. The second section 210 includes a first set of baffles that create a first stage 211 and a second set of baffles that create a second stage 221. The first stage 211 includes an enter baffle 212, a bottom baffle 213, and a turning baffle 216, and having an orifice 215 with a height 214. The second stage 221 includes an enter baffle 222, a bottom baffle 223, and a turning baffle 226, and having an orifice 225 with a height 224. As can be seen in FIGS. 5 and 6B, all of the baffles in the second section 210 can be located lower in the housing 105 than the baffles in the first section 110. By way of example and as shown, the bottom baffle 213 of the first stage 211 in the second section 210 can be located closer to the bottom of the housing 105 along a height h of the side of the housing 105 where the air inlet 101 is located than the bottom baffle 113 of the first stage 111 in the first section 110. The bottom baffle 223 of the second stage 221 in the second section 210 can be located closer to the bottom of the housing 105 along the height h than the bottom baffle 123 of the second stage 121 in the first section 110.

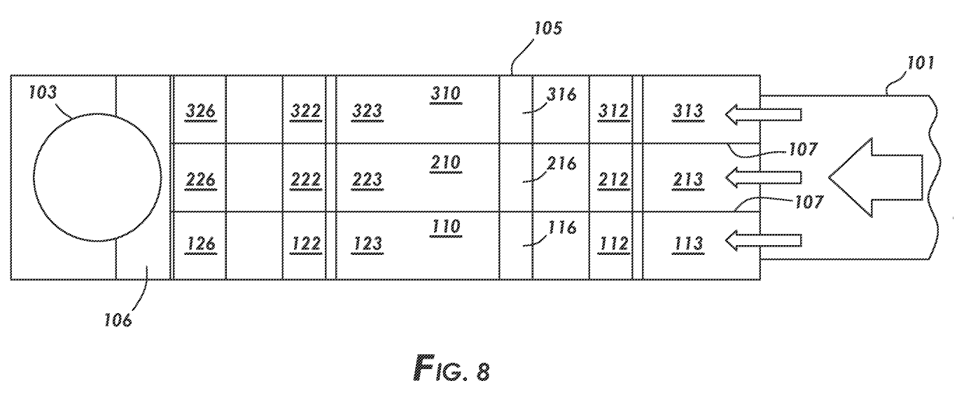

FIG. 7A shows the third section 310 located at a back side of the housing 105. The third section 310 includes a first set of baffles that create a first stage 311 and a second set of baffles that create a second stage 321. The first stage 311 includes an enter baffle 312, a bottom baffle 313, and a turning baffle 316, and having an orifice 315 with a height 314. The second stage 321 includes an enter baffle 322, a bottom baffle 323, and a turning baffle 326, and having an orifice 325 with a height 324. As can be seen in FIG. 7B, all of the baffles in the third section 310 can be located lower in the housing 105 than the baffles in the second section 210. By way of example and as shown, the bottom baffle 313 of the first stage 311 in the third section 310 can be located closer to the bottom of the housing 105 along a height h of the side of the housing 105 where the air inlet 101 is located than the bottom baffle 213 of the first stage 211 in the second section 210. The bottom baffle 323 of the second stage 321 in the third section 310 can be located closer to the bottom of the housing 105 along the height h than the bottom baffle 223 of the second stage 221 in the second section 210. Accordingly, the length of the vertical portion of the enter baffle 312 can be greater than the length of the enter baffle 212, which can be greater than the length of the enter baffle 112. In this manner, the baffles in the third section 310 can be lower in the water 410 than the baffles in the second section 210, which can be lower in the water than the baffles in the first section 110. As with the discussion regarding the first section 110, the orifice 325 can be higher (in relation to the top of the housing 105) than the orifice 315, and the orifice 225 can be higher than the orifice 215. The orifice heights (e.g., 324, 314, 224, and 214) can be the same as or different from the orifice heights in other sections. By way of example, the height 324 of the orifice 325 can be the same as or different from the height 224 of the orifice 225. FIG. 8, is a top view showing the baffles in all 3 sections.

As discussed above regarding the air pressure/flow at which the dust particulates and air enter the wet scrubber 100 in the first section 110, if the air flow is too high, then there is not a sufficient back pressure from the water to force the air/dust particulates to jet through the orifice 115 and cause the necessary turbulent flow 118 in order to capture the dust particulates. A significant feature and advantage is that by including the second section 210 and optionally the third section 310 means that these other sections can take over for the first section 110 and/or the second section 210 when the air pressure/flow is too high. Because the baffles in the second section 210 are lower in the water than the baffles in the first section 110, the water level is not forced down below the bottom baffle 213 and there can be a sufficient amount of back pressure from the water to cause the air/dust particulates to jet through the orifice 215 and cause the necessary turbulent flow between the turning baffle 216 and the enter baffle 212 in the first stage 211. If the air pressure/flow is too high for the second section 210, then the third section 310 can take over. By way of a non-limiting example, the first section 110 can accommodate air flow in the range of 0.2 to 100 cubic feet per minute (ft³/min. or cfm) (0.006 to 2.832 cubic meters per minute “m³/min.”, the second section 210 can accommodate air flow in the range of 100 to 200 ft³/min. (2.83 to 5.66 m³/min.), and the third section 310 can accommodate air flow in the range of 200 to 1,000 ft³/min. (5.66 to 28.32 m³/min.). Accordingly, the wet scrubber can accommodate varying air flow unlike current wet scrubbers that require a constant air flow. “Accommodate” in this sense means that the air/dust particulates jet through the orifice in the first stage and/or second stage for a given section and turbulent flow occurs whereby at least some of the dust particulates are captured by the water. When the air flow exceeds the upper limit of the first section 110 (e.g., at air flow greater than 100 cfm), then the first section 110 is still flowing at 100 cfm and capturing the dust particulates in that air flow, and the second section 210 opens (via air pressure) and takes the “extra” air flow over 100 cfm. When the air flow exceeds the upper limit of the air flow range of the second section 210 (e.g., above 200 cfm), then the third section 310 opens, whereby the first section 110 is scrubbing up to its upper limit, the second section 210 is scrubbing up to its upper limit, and the third section 310 takes the extra air flow. According to any of the embodiments, the amount of dust particulates that are captured by the water located in the wet scrubber is at least 75%, preferably at least 85%, and more preferably at least 100%.

The water in the wet scrubber captures the dust particulates, for example from a bulk cement powder. The concentration of the dust particulates that are captured in the water will continually increase with use and become “dirty” water. When the concentration reaches a certain level, the housing may need to be filled with clean water. The water can also be changed out after each job in which it is used. The dirty water can be removed from the housing, for example, via the water outlet 104 or a port (not shown). The dirty water can be stored in a storage container and then used as the water source into the mixer head or transported to another wellsite or location, or the dirty water can be pumped from the wet scrubber 100 directly into the mixer head 11 or pumped directly into the water feed tube 17 to be combined with other liquids such as water, oil, or liquid additives. If cement is the bulk powder, then using the dirty water in the mixing system 10 can reduce the amount of bulk cement that is needed to form the cement slurry because the dirty water already includes some cement. After the dirty water is removed from the wet scrubber, then clean water can be added back to fill the housing 105 with the desired volume of water. It is also possible to have the dirty water and clean water run on a continuous loop wherein the dirty water is being removed from the housing 105 while at the same time the clean water is being added. Alternatively, operation of the wet scrubber 100 can be stopped, the entire volume of dirty water in the housing removed, and clean water added back to the housing. The wet scrubber can also be transported to another wellsite after the dirty water has been removed, and then filled with clean water at the new wellsite. This can be accomplished, for example, by draining all of the dirty water from the housing 105, for example, via a water outlet 104 like shown in FIG. 2; or draining all of the dirty water from the water tank 400 like shown in FIG. 3.

An embodiment of the present disclosure is a system for capturing dust particulates comprising: a mixer head, wherein a bulk powder is pneumatically conveyed into the mixer head; a fan located at a top of the mixer head; a wet scrubber comprising: a housing; an air inlet, wherein air and the dust particulates flow through the air inlet from the fan; a volume of water contained within the housing; a first section comprising: a first set of baffles creating a first stage; and a second set of baffles creating a second stage; and an air outlet, wherein the dust particulates interact with the water and the water captures the dust particulates; a treatment fluid formed in a mixer; and a pump configured to pump the treatment fluid into a subterranean formation. Optionally, the air inlet is located at a top of one side of the housing. Optionally, an air pressure at which the dust particulates and air enter the wet scrubber via the air inlet is variable. Optionally, the wet scrubber further comprises a water inlet. Optionally, a pump is used to pump the volume of water into the housing from a water storage container. Optionally, the system further comprises a water tank comprising a water outlet and pipe connecting the water outlet to the water inlet, wherein the volume of the water fills the housing from the water tank, and wherein a water level in the water tank is the same as a water level in the housing. Optionally, a bottom of the housing is open, wherein the wet scrubber is attached to an inside of a water tank, and wherein a water level in the housing is the same as a water level in the water tank. Optionally, the first set of baffles for the first stage comprise an enter baffle, a bottom baffle, and a turning baffle, and wherein the second set of baffles for the second stage comprise an enter baffle, a bottom baffle, and a turning baffle. Optionally, the enter baffles of the first stage and the second stage comprise a vertical portion and an angled portion that angles away from vertical portion, wherein the bottom baffles of the first stage and the second stage are perpendicular to or angled from the vertical portion of the enter baffles, wherein an end of the angled portion of the enter baffles is located a distance from an end of the bottom baffles and forms an orifice, and wherein the distance is a height of the orifice. Optionally, the height of the orifice of the second stage is greater than or equal to the height of the orifice of the first stage. Optionally, an end of a lower segment of the turning baffles of the first and second stage is located below the orifices of the first and second stage, respectively. Optionally, every baffle in the second stage is located closer to a top of the housing and higher in relation to a water level in the housing than their corresponding baffle in the first stage. Optionally, the system further comprises: a second section, wherein the second section comprises: a first set of baffles creating a first stage, wherein the first set of baffles comprise an enter baffle, a bottom baffle, and a turning baffle; and a second set of baffles creating a second stage, wherein the second set of baffles comprise an enter baffle, a bottom baffle, and a turning baffle; a section partition, wherein the section partition separates the set of baffles in the first section from the set of baffles in the second section; and an opening in the section partition, wherein the opening allows water to flow between the first and second sections. Optionally, all the baffles in the second section are located lower in the housing than all the baffles in the first section. Optionally, the system further comprises: a third section, wherein the third section comprises: a first set of baffles creating a first stage, wherein the first set of baffles comprise an enter baffle, a bottom baffle, and a turning baffle; and a second set of baffles creating a second stage, wherein the second set of baffles comprise an enter baffle, a bottom baffle, and a turning baffle; and a second section partition, wherein the second section partition separates the set of baffles in the second section from the set of baffles in the third section; an opening in the second section partition, wherein the opening allows water to flow between the second and third sections. Optionally, all the baffles in the third section are located lower in the housing than all the baffles in the second section. Optionally, the treatment fluid is a cement slurry, and the bulk powder is cement.

Another embodiment of the present disclosure is a method of capturing dust particulates in a wet scrubber comprising: pneumatically conveying a bulk powder into a mixer head, wherein the dust particulates are created during the conveyance; conveying water into the mixer head; mixing the bulk powder and the water to form a treatment fluid; removing dust particulates and air from the mixer head; flowing the dust particulates and the air into the wet scrubber, wherein the wet scrubber comprises: a housing; an air inlet, wherein the dust particulates and the air flow into the wet scrubber through the air inlet; a volume of water contained within the housing; a first section comprising: a first set of baffles creating a first stage; and a second set of baffles creating a second stage; and an air outlet; causing or allowing the dust particulates to interact with the water contained within the housing, wherein the water captures the dust particulates via the interaction; and pumping the treatment fluid into a subterranean formation. Optionally, the interaction is a turbulent flow within an area defined between an enter baffle, a bottom baffle, and a turning baffle in the first stage. Optionally, the air and remaining dust particulates enter the second stage from the first stage, and wherein a turbulent flow occurs within an area defined between an enter baffle, a bottom baffle, and a turning baffle in the second stage. Optionally, the air inlet is located at a top of one side of the housing. Optionally, an air pressure at which the dust particulates and air enter the wet scrubber via the air inlet is variable. Optionally, the wet scrubber further comprises a water inlet. Optionally, a pump is used to pump the volume of water into the housing from a water storage container. Optionally, the system further comprises a water tank comprising a water outlet and pipe connecting the water outlet to the water inlet, wherein the volume of the water fills the housing from the water tank, and wherein a water level in the water tank is the same as a water level in the housing. Optionally, a bottom of the housing is open, wherein the wet scrubber is attached to an inside of a water tank, and wherein a water level in the housing is the same as a water level in the water tank. Optionally, the first set of baffles for the first stage comprise an enter baffle, a bottom baffle, and a turning baffle, and wherein the second set of baffles for the second stage comprise an enter baffle, a bottom baffle, and a turning baffle. Optionally, the enter baffles of the first stage and the second stage comprise a vertical portion and an angled portion that angles away from vertical portion, wherein the bottom baffles of the first stage and the second stage are perpendicular to or angled from the vertical portion of the enter baffles, wherein an end of the angled portion of the enter baffles is located a distance from an end of the bottom baffles and forms an orifice, and wherein the distance is a height of the orifice. Optionally, the height of the orifice of the second stage is greater than or equal to the height of the orifice of the first stage. Optionally, an end of a lower segment of the turning baffles of the first and second stage is located below the orifices of the first and second stage, respectively. Optionally, every baffle in the second stage is located closer to a top of the housing and higher in relation to a water level in the housing than their corresponding baffle in the first stage. Optionally, the wet scrubber further comprises: a second section, wherein the second section comprises: a first set of baffles creating a first stage, wherein the first set of baffles comprise an enter baffle, a bottom baffle, and a turning baffle; and a second set of baffles creating a second stage, wherein the second set of baffles comprise an enter baffle, a bottom baffle, and a turning baffle; a section partition, wherein the section partition separates the set of baffles in the first section from the set of baffles in the second section; and an opening in the section partition, wherein the opening allows water to flow between the first and second sections. Optionally, all the baffles in the second section are located lower in the housing than all the baffles in the first section. Optionally, the wet scrubber further comprises: a third section, wherein the third section comprises: a first set of baffles creating a first stage, wherein the first set of baffles comprise an enter baffle, a bottom baffle, and a turning baffle; and a second set of baffles creating a second stage, wherein the second set of baffles comprise an enter baffle, a bottom baffle, and a turning baffle; and a second section partition, wherein the second section partition separates the set of baffles in the second section from the set of baffles in the third section; an opening in the second section partition, wherein the opening allows water to flow between the second and third sections. Optionally, all the baffles in the third section are located lower in the housing than all the baffles in the second section. Optionally, the treatment fluid is a cement slurry, and the bulk powder is cement.

Therefore, the various embodiments are well adapted to attain the ends and advantages mentioned as well as those that are inherent therein. The particular embodiments disclosed above are illustrative only, as the various embodiments may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words "comprise," "have," "include," and all grammatical variations thereof are each intended to have an open, non-limiting meaning that does not exclude additional elements or steps. While compositions, systems, and methods are described in terms of "comprising," "containing," or "including" various components or steps, the compositions, systems, and methods also can "consist essentially of" or "consist of" the various components and steps. It should also be understood that, as used herein, "first," "second," and "third," are assigned arbitrarily and are merely intended to differentiate between two or more sections, stages, etc., as the case may be, and do not indicate any sequence. Furthermore, it is to be understood that the mere use of the word "first" does not require that there be any "second," and the mere use of the word "second" does not require that there be any "third," etc.

Whenever a numerical range with a lower limit and an upper limit is disclosed, any number and any included range falling within the range is specifically disclosed. In particular, every range of values (of the form, "from about a to about b," or, equivalently, "from approximately a to b," or, equivalently, "from approximately a - b") disclosed herein is to be understood to set forth every number and range encompassed within the broader range of values. Also, the terms in the claims have their plain, ordinary meaning unless otherwise explicitly and clearly defined by the patentee. Moreover, the indefinite articles "a" or "an," as used in the claims, are defined herein to mean one or more than one of the elements that it introduces. If there is any conflict in the usages of a word or term in this specification and one or more patent(s) or other documents that may be incorporated herein by reference, the definitions that are consistent with this specification should be adopted.

What is claimed is:

1. A system for capturing dust particulates comprising:
a mixer head, wherein a bulk powder is pneumatically conveyed into the mixer head;
a fan located at a top of the mixer head;
a wet scrubber comprising:
a housing;
an air inlet, wherein air and the dust particulates flow through the air inlet from the fan;
a volume of water contained within the housing;
a first section comprising:
a first set of baffles creating a first stage; and
a second set of baffles creating a second stage; and
an air outlet,
wherein the dust particulates interact with the water and the water captures the dust particulates;
a treatment fluid formed in a mixer; and
a pump configured to pump the treatment fluid into a subterranean formation.

2. The system according to claim 1, wherein the air inlet is located at a top of one side of the housing.

3. The system according to claim 1, wherein an air pressure at which the dust particulates and air enter the wet scrubber via the air inlet is variable.

4. The system according to claim 1, wherein the wet scrubber further comprises a water inlet.

5. The system according to claim 4, wherein a pump is used to pump the volume of water into the housing from a water storage container.

6. The system according to claim 5, further comprising a water tank comprising a water outlet and pipe connecting the water outlet to the water inlet, wherein the volume of the water fills the housing from the water tank, and wherein a water level in the water tank is the same as a water level in the housing.

7. The system according to claim 1, wherein a bottom of the housing is open, wherein the wet scrubber is attached to an inside of a water tank, and wherein a water level in the housing is the same as a water level in the water tank.

8. The system according to claim 1, wherein the first set of baffles for the first stage comprise an enter baffle, a bottom baffle, and a turning baffle, and wherein the second set of baffles for the second stage comprise an enter baffle, a bottom baffle, and a turning baffle.

9. The system according to claim 8,
wherein the enter baffles of the first stage and the second stage comprise a vertical portion and an angled portion that angles away from vertical portion,
wherein the bottom baffles of the first stage and the second stage are perpendicular to or angled from the vertical portion of the enter baffles,
wherein an end of the angled portion of the enter baffles is located a distance from an end of the bottom baffles and forms an orifice, and
wherein the distance is a height of the orifice.

10. The system according to claim 9, wherein the height of the orifice of the second stage is greater than or equal to the height of the orifice of the first stage.

11. The system according to claim 9, wherein an end of a lower segment of the turning baffles of the first and second stage is located below the orifices of the first and second stage, respectively.

12. The system according to claim 8, wherein every baffle in the second stage is located closer to a top of the housing and higher in relation to a water level in the housing than their corresponding baffle in the first stage.

13. The system according to claim 1, further comprising:
a second section, wherein the second section comprises:
a first set of baffles creating a first stage, wherein the first set of baffles comprise an enter baffle, a bottom baffle, and a turning baffle; and
a second set of baffles creating a second stage, wherein the second set of baffles comprise an enter baffle, a bottom baffle, and a turning baffle;
a section partition, wherein the section partition separates the set of baffles in the first section from the set of baffles in the second section; and
an opening in the section partition, wherein the opening allows water to flow between the first and second sections.

14. The system according to claim 13, wherein all the baffles in the second section are located lower in the housing than all the baffles in the first section.

15. The system according to claim 13, further comprising:
a third section, wherein the third section comprises:
a first set of baffles creating a first stage, wherein the first set of baffles comprise an enter baffle, a bottom baffle, and a turning baffle; and
a second set of baffles creating a second stage, wherein the second set of baffles comprise an enter baffle, a bottom baffle, and a turning baffle; and
a second section partition, wherein the second section partition separates the set of baffles in the second section from the set of baffles in the third section;
an opening in the second section partition, wherein the opening allows water to flow between the second and third sections.

16. The system according to claim 15, wherein all the baffles in the third section are located lower in the housing than all the baffles in the second section.

17. The system according to claim 1, wherein the treatment fluid is a cement slurry, and the bulk powder is cement.

18. A method of capturing dust particulates in a wet scrubber comprising:
pneumatically conveying a bulk powder into a mixer head, wherein the dust particulates are created during the conveyance;
conveying water into the mixer head;
mixing the bulk powder and the water to form a treatment fluid;
removing dust particulates and air from the mixer head;
flowing the dust particulates and the air into the wet scrubber, wherein the wet scrubber comprises:
a housing;
an air inlet, wherein the dust particulates and the air flow into the wet scrubber through the air inlet;
a volume of water contained within the housing;
a first section comprising:
a first set of baffles creating a first stage; and
a second set of baffles creating a second stage; and
an air outlet;
causing or allowing the dust particulates to interact with the water contained within the housing, wherein the water captures the dust particulates via the interaction; and
pumping the treatment fluid into a subterranean formation.

19. The method according to claim 18, wherein the interaction is a turbulent flow within an area defined between an enter baffle, a bottom baffle, and a turning baffle in the first stage.

20. The method according to claim 19, wherein the air and remaining dust particulates enter the second stage from the first stage, and wherein a turbulent flow occurs within an area defined between an enter baffle, a bottom baffle, and a turning baffle in the second stage.
